(19) United States
(12) Patent Application Publication
(10) Pub. No.: US 2006/0209780 A1
(43) Pub. Date: Sep. 21, 2006

(54) Data transfer in TDMA system

(75) Inventors: Eero Nikula, Espoo (FI); Risto Timisjarvi, Jaali (FI); Tommi Jokela, Helsinki (FI); Harri Jokinen, Pertteli (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/266,387

(22) Filed: Nov. 4, 2005

Related U.S. Application Data
(60) Provisional application No. 60/645,031, filed on Jan. 21, 2005.

(51) Int. Cl. H04B 7/212

(52) U.S. Cl. 370/347; 370/442

(57) ABSTRACT

A solution for the transmission of data in a time division multiple access (TDMA) based communication system is provided. A plurality of time slots in a TDMA frame is allocated to a subscriber unit for the transmission of speech data. The extra capacity provided to the subscriber unit is used for increasing the error tolerance of the speech data by adding extra redundancy to the speech data.

### Field

The invention relates to the transfer of data between a communication device and a communication network in a TDMA-based communication system.

### Background

The Global System for Mobile Communications (GSM) is today a widely deployed communication system. The GSM system. may be described as a speech-centric TDMA (Time Division Multiple Access) based cellular mobile communication system. The transfer of speech data is the main function of the GSM system, though other types of data (such as e-mail data, Internet-related data) are transferred to some degree, too.

The coverage, particularly speech coverage, of a mobile communication system is also an important factor in the GSM system. Improving the speech coverage would be advantageous, since the sparsely populated areas of the globe will be covered in the near future. In sparsely populated areas capacity demands from the communication network are quite low and, thus, cell ranges are higher than in densely populated areas. A limitation to the cell range, and consequently to the speech coverage, is set by attenuating radio signals over long distances between a subscriber unit and a serving base station.

One way to define the speech coverage of the GSM system is to use speech link budget calculations. The speech link budget can be improved, for example, by increasing transmit power, improving receiver sensitivity and/or using low bit rate speech coding. However, within the definitions of the current GSM standard, the use of the above-mentioned improvements is very limited and additional solutions for improving the speech coverage are needed.

### BRIEF DESCRIPTION OE THE INVENTION

An object of the invention is to provide an improved solution for transmitting data in a TDMA-based communication system.

According to an aspect of the invention, there is provided a data transmission method in a time division multiple access (TDMA) based communication system, the method comprising allocating a plurality of time slots of a TDMA frame to a subscriber unit for the transmission of speech data, increasing the redundancy of speech data of the subscriber unit by exploiting the extra capacity provided to the subscriber unit in the form of a plurality of allocated time slots, and transmitting speech data with increased redundancy during the plurality of time slots allocated to the subscriber unit, the payload of the speech data corresponding to the payload of one time slot of a TDMA frame.

According to another aspect of the invention, there is provided a transceiver unit of a time division multiple access (TDMA) based communication system, the transceiver unit comprising a communication interface to provide a connection to another transceiver unit and a control unit. The control unit is configured to increase the redundancy of the speech data of the subscriber unit by exploiting the extra capacity provided to the subscriber unit in the form of a plurality of allocated time slots, and transmit the speech data with increased redundancy during the plurality of time slots allocated to the subscriber unit, the payload of the speech data corresponding to the payload of one time slot of a TDMA frame.

According to another aspect of the invention, there is provided a network element of a time division multiple access (TDMA) based communication system, the network element comprising a control unit configured to allocate a plurality of time slots of a TDMA frame to a subscriber unit for the transmission of speech data.

According to yet another aspect of the invention, there is provided an arrangement for transmitting data in a time division multiple access (TDMA) based communication system, the arrangement comprising a network element and a transceiver unit. The network element comprises means for allocating a plurality of time slots of a TDMA frame to a subscriber unit for the transmission of speech data. The transceiver unit comprising means for increasing the redundancy of the speech data of the subscriber unit by exploiting the extra capacity provided to the subscriber unit in the form of plurality of allocated time slots and means for transmitting the speech data with increased redundancy during the plurality of time slots allocated to the subscriber unit, the payload of the speech data corresponding to the payload of one time slot of a TDMA frame.

According to another aspect of the invention, there is provided a computer program product encoding a computer program of instructions for executing a computer process for transmitting data in a time division multiple access (TDMA) based communication system. The process comprises allocating a plurality of time slots of a TDMA frame to a subscriber unit for the transmission of speech data, increasing the redundancy of the speech data of the subscriber unit by exploiting the extra capacity provided to the subscriber unit in the form of a plurality of allocated time slots, and transmitting the speech data with increased redundancy during the plurality of time slots allocated to the subscriber unit, the payload of the speech data corresponding to the payload of one time slot of a TDMA frame.

According to yet another aspect of the invention, there is provided a computer program distribution medium readable by a computer and encoding a computer program of instructions for executing a computer process for transmitting data in a time division multiple access (TDMA) based communication system. The process comprises allocating a plurality of time slots of a TDMA frame to a subscriber unit for the transmission of speech data, increasing the redundancy of the speech data of the subscriber unit by exploiting the extra capacity provided to the subscriber unit in the form of a plurality of allocated time slots, and transmitting the speech data with increased redundancy during the plurality of time slots allocated to the subscriber unit, the payload of the speech data corresponding to the payload of one time slot of a TDMA frame.

As an advantage over the existing solutions, the invention provides an extension to the speech coverage of a TDMA-based communication system. Thus, the cell range of a communication network may be increased and, consequently, less base stations are needed to provide speech services in sparsely populated areas.

### LIST OF DRAWINGS

In the following, the invention will be described in greater detail with reference to embodiments and the accompanying drawings, in which

FIG. 1 shows a block diagram of a GSM communication system;

FIG. 2A illustrates an example of a structure of a subscriber unit according to an embodiment of the invention;

FIG. 2B illustrates an example of a structure of a subscriber unit according to an embodiment of the invention;

FIG. 3 illustrates time slot allocation in a GSM system according to an embodiment of the invention;

FIG. 4 illustrates the use of allocated time slots according to an embodiment of the invention;

FIG. 5 is a flow diagram describing a process for transmitting data in a GSM system according to an embodiment of the invention;

FIG. 6A illustrates the use of allocated time slots according to an embodiment of the invention; and

FIG. 6B illustrates the use of allocated time slots according to an embodiment of the invention.

### DESCRIPTION OF EMBODIMENTS

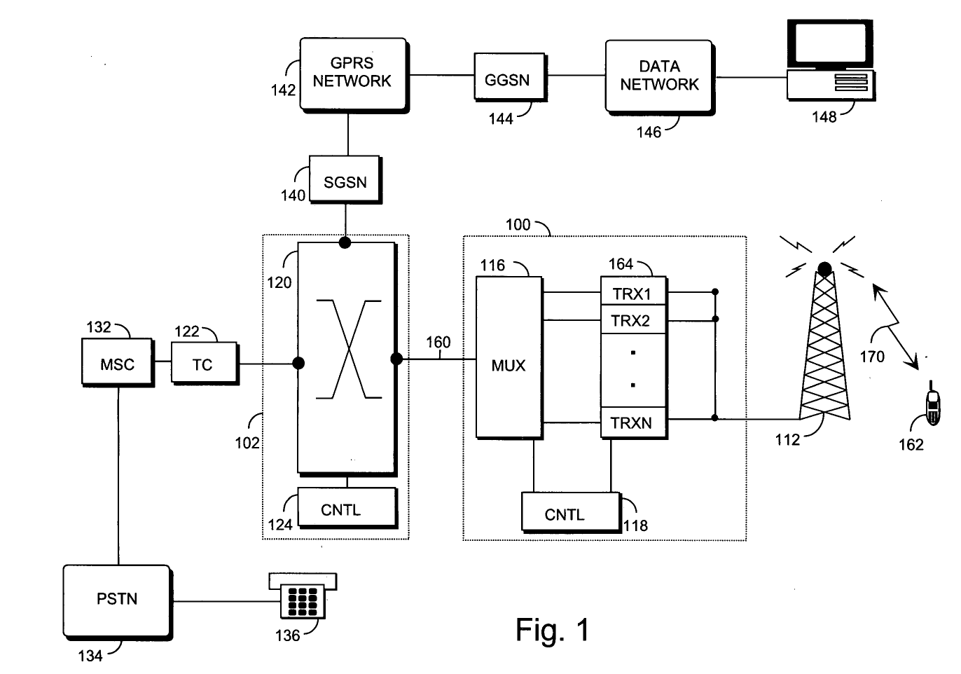

A typical structure of a communication system according to preferred embodiments of the present invention and its interfaces with a fixed telephone network and a packet-switched network are described with reference to FIG. 1. FIG. 1 only contains the blocks that are essential to explaining the embodiments, but it is clear to a person skilled in the art that a conventional cellular packet network also contains other functions and structures that need not be explained in more detail herein. As an example, the GSM communication system will be used in describing the embodiments of the invention, but the invention is not limited to the GSM communication system. The embodiments of the invention may also be applied to other TDMA-based systems.

A cellular network typically comprises a fixed network infrastructure, i.e. a network part, and subscriber units, which can be fixed, installed in a vehicle, or portable terminals. The network part includes base stations 100 and base station controllers 102. A base station controller 102 connected to several base stations 100 controls the base stations 100 in a centralized manner. The base station 100 includes communication interfaces 164. A base station 100 typically includes one to sixteen communication interfaces 164. One communication interface 164 provides radio capacity for one TDMA frame, i.e. typically for eight time-slots in a GSM system.

The base station 100 comprises a control unit 118 that controls the operation of the communication interfaces 164 and a multiplexer 116. The multiplexer 116 switches traffic and control channels used by several transceivers 164 on one transmission link 160. The structure of the transmission link 160 is exactly defined, and it is called an Abis interface.

The communication interfaces 164 of the base station 100 are connected to an antenna unit 112, which establishes a bi-directional radio link 170 to a subscriber unit 162. The structure of frames transmitted on the bi-directional radio link 170 is also exactly defined, and the link is called an air interface. The subscriber unit 162 can be a regular mobile phone, for instance.

The base station controller 102 comprises a switching field 120 and a control unit 124. The switching field 120 is used for switching speech and data and for connecting signaling circuits. A base station system made up of the base station 100 and the base station controller 102 also comprises a transcoder 122. The transcoder 122 usually resides as close to a mobile switching center 132 as possible, because it is then possible to transmit speech in cellular network format between the transcoder 122 and the base station controller 102, thus saving transmission capacity.

The transcoder 122 transforms the different digital speech-coding formats used between a public switched telephone network and a radio telephone network to suit each other, for instance from the 64 kbit/s format of a fixed network to a cellular radio network format (e.g.13 kbit/s) and vice versa. The control unit 124 takes care of call control, mobility management, the use of radio channels, the collection of statistics, signaling, and various maintenance tasks.

As shown in FIG. 1, connections (shown as black dots) can be set up with the switching field 120 both to a public switched telephone network 134 through a mobile switching center 132 and to a packet-switched network 142. A typical terminal 136 in the public switched telephone network 134 is a conventional phone or an ISDN (Integrated Services Digital Network) phone.

The connection between the packet transmission network 142 and the switching field 120 is established by a serving GPRS support node (SGSN) 140. A task of the serving GPRS support node 140 is to transmit packets between the base station system and a gateway GPRS support node (GGSN) 144, and to record the position of the subscriber unit 162 in its area.

The gateway GPRS support node 144 connects a public packet transmission network 146 and the packet transmission network 142. An Internet protocol or an X.25 protocol can be used at the interface. The gateway GPRS support node 144 hides the internal structure of the packet transmission network 142 by encapsulation from the public packet transmission network 146 so that to the public packet transmission network 146, the packet transmission network 142 seems like a sub-network, and the public packet transmission network 146 can address packets to and receive packets from the subscriber terminal 162 therein.

Typically, the packet transmission network 142 is a private network, which uses an Internet protocol and transfers signaling and tunneled user data. Depending on the operator, the structure of the network 142 may vary in its architecture and protocols below the Internet protocol layer.

The can be the Internet, for instance. A terminal 148, such as a server, may be connected to the public packet transmission network 146 in order to transmit packets to the subscriber units 162.

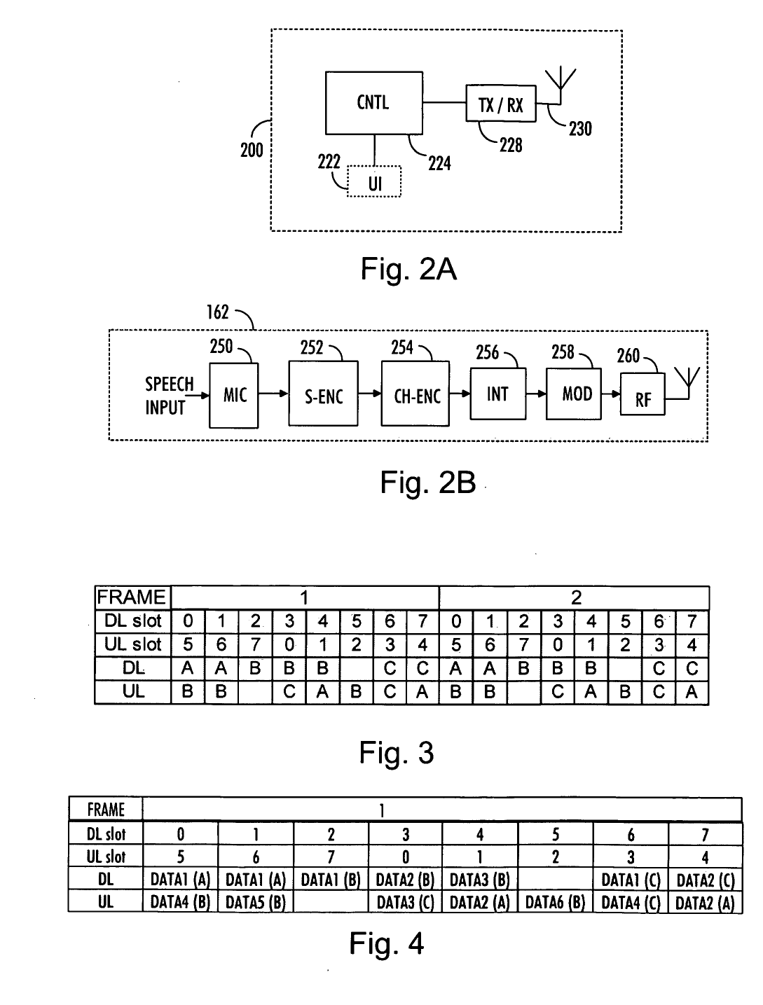

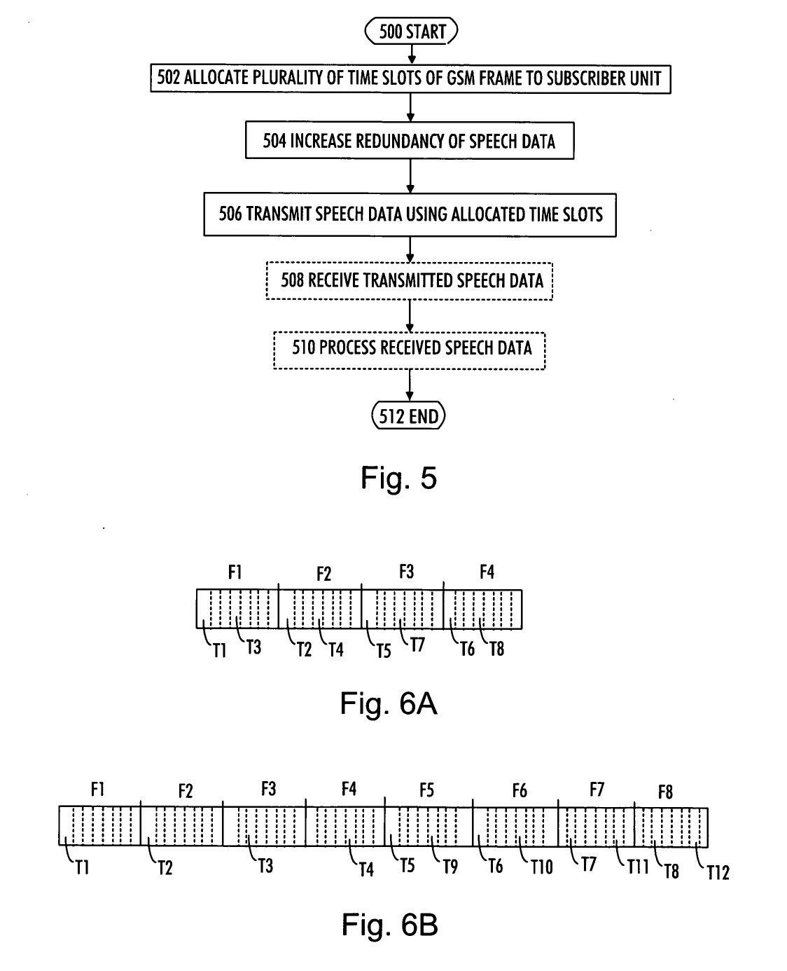

Next, the structure of a transceiver unit in which the embodiments of the invention may be implemented, will be described with reference to FIG. 2A. A transceiver unit 200 may be a subscriber unit of a TDMA-based communication system or a network element, such as a base station, of a TDMA-based communication system. The transceiver unit 200 comprises a communication interface 228 to provide a wireless radio connection with another transceiver unit or units through an antenna 230 of the transceiver unit 200. When the transceiver unit 200 is a subscriber unit, the communication interface 228 may provide a connection with, for example, the GSM network through a serving base station, thus enabling not only regular GSM circuitswitched voice call connections but also packet-switched GPRS or EPGRS connections.

The transceiver unit 200 further comprises a control unit 224 to control the functions of the transceiver unit 200. The control unit 224 handles the establishment, operation and termination of radio connections in the transceiver unit 200. Additionally the control unit 224 controls the transmission and reception of information between the transceiver unit 200 and other transceiver units it communicates with. The control unit 224 controls the processing of transmission and reception signals. The control unit 224 may be implemented with a digital signal processor with suitable software or with separate logic circuits, for example with ASIC (Application-Specific Integrated Circuit).

The transceiver unit 200 may further comprise a user interface 222 connected to the control unit 224. In a subscriber unit, the user interface 222 may comprise a keypad, microphone, loudspeaker, display, and/or camera.

Next, the structure of the subscriber unit 162 will be described with reference to FIG. 2B, which is a block diagram illustrating the functional units of the subscriber unit performing determined operations. These operations relate to the transmission of speech data in the subscriber unit. It should be appreciated that FIG. 2B illustrates only the blocks essential to describe the transmission of speech data according to an embodiment of the invention, and the subscriber unit may also perform additional operations.

In the transmission of speech data, the first operation is to receive a speech input from a user of the subscriber unit. The speech input is received through a microphone 250 which converts the acoustic speech signal into an analog electric signal.

From the microphone 250, the electric speech signal is fed to a speech encoder 252 which converts the analog speech signal into a digital form by using, for example, pulse code modulation (PCM). Then, the speech encoder 252 encodes the digitized speech signal according to a determined speech encoding procedure. The procedure may comprise operations performed by a speech encoder according to GSM specifications provided by ETSI (European Telecommunications Standards Institute). As an output, the speech encoder provides encoded speech data with a desired bit rate.

After speech encoding, the speech data is fed to a channel encoder 254 which adds redundant information to the speech data in order to improve error tolerance. In order to add redundant data to the speech data, the speech data may be processed with a convolutional encoder, as in the GSM system.

The amount of redundant data added to the speech data is determined with a code rate on the channel encoder 254. The code rate R_{c} is expressed as R_{c}=k/n, where k is the number of bits fed to the channel encoder and n is the number of output bits from the channel encoder. The code rate actually determines the number of output bits from a set of input bits fed to the channel encoder. The more output bits per a number of input bits, the stronger the channel coding and the better the error tolerance of the speech signal. Thus, by using strong channel coding, the code rate is decreased. The channel encoder 254 may perform convolutional channel encoding according to the GSM specifications.

When the speech data has been channel encoded, the encoded speech data is fed to an interleaver 256 which interleaves the encoded speech data in order to reduce the effects of burst-type errors. The interleaver 256 may perform interleaving according to the GSM specifications, thus producing interleaved speech data.

The interleaved speech data is fed to a modulator 258 which modulates the received speech data bits into electrical baseband waveforms. The modulator 258 may perform the modulation according to the GSM specifications using Gaussian minimum shift keying (GMSK) modulation, thus producing a modulated baseband speech signal.

The modulated speech signal is then fed to a radio frequency (RF) unit 260 which takes care of converting the baseband speech signal into a radio frequency signal and amplifying the speech signal for transmission. The RF unit 260 may also filter the speech signal in order to suppress undesired frequency components. The RF unit 260 also transmits speech data using an antenna of the subscriber unit 162.

A receiver structure of the subscriber unit 162 performs inverse operations of the operations described above. A speech signal is received through the antenna and converted to baseband. Then, the received speech signal is demodulated, deinterleaved, and the channel encoding is decoded. Next, the signal is fed to a speech decoder which decodes the speech signal and converts the speech signal into an analog form. Then the analog speech signal is fed to a loudspeaker which converts the analog electrical speech signal into an acoustic speech signal which is audible to the user of the subscriber unit 162.

Next, an embodiment of the invention will be described with reference to FIG. 3, which illustrates the allocation of time slots in a TDMA frame.

During a speech connection set up process, the GSM communication network allocates to a subscriber unit specified time slots for transmitting or receiving information. The allocation of time slots may be carried out by a network element, for example a base station controller. The available time slots are distributed among subscriber units using the same frequency channel. Typically, one time slot in a TDMA frame comprising a total of eight time slots is allocated to a subscriber unit. The operations described next may be carried out in a transceiver unit 200 described above. The transceiver unit 200 may be a subscriber unit 162 or a base station.

In order to improve the speech coverage of a TDMA-based communication system, a plurality of time slots may be allocated to a subscriber unit for the transfer of speech data. As FIG. 3 illustrates, there are multiple time slots allocated to each user A, B and C having a subscriber unit in the TDMA frames in both downlink and uplink directions. There are two time slots allocated to both users A and C, and three time slots allocated to user B in both downlink and uplink directions. This may indicate that user B resides further away from a serving base station than users A and C, and thus the network element allocating time slots may have determined that three time slots should be allocated to user B. In downlink direction, the time slots for each user are allocated to adjacent time slots. This is one option but the time slots for each user may also be allocated in a distributed manner, as the uplink direction of FIG. 3 illustrates. The time slots may also be allocated unevenly so that there is a different number of time slots in different TDMA frames allocated to a user. In addition to allocating a plurality of time slots of a TDMA frame for transfer of speech data in a traffic channel of the TDMA-based communication system, a plurality of time slots of a TDMA frame may also be allocated for transfer of signalling information in control channels.

When considering a speech connection between first and second subscriber units of a communication system, it is not necessary to allocate the same number of time slots for both subscriber units. Preferably, multiple time slots are allocated, when it is determined that the error tolerance of speech data should be increased. Thus, the allocation of multiple time slots to the first subscriber unit is determined for an air interface connection between the first subscriber unit and a base station serving the first subscriber unit regardless of whether there are multiple time slots allocated to the second subscriber unit. Instead of a speech connection between two subscriber units, the speech connection may naturally be connected between a subscriber unit and a terminal of a public switched telephone network.

As mentioned above, the actual purpose of allocating a plurality of time slots for a user is not to increase the payload data rate of speech data, but to increase the redundancy of the speech data in a way that makes the transmission of speech data more error tolerant. The allocated time slots are used to transmit the same speech data, as would be transmitted if only a single time slot per TDMA frame were allocated to the subscriber unit. Now, the same speech data is transmitted using multiple time slots per TDMA frame. Thus, the speech coverage of the communication network may be improved. FIG. 4 illustrates, how the additional time slot(s) allocated to a user may be exploited in order to improve the error tolerance of speech data. The time slots in the TDMA frame are allocated as in FIG. 3 between users A, B and C, and only the first frame is illustrated.

The additional time slots may be used for transmitting the same speech data a number of times. The speech data may be processed in a transmitter as if only one time slot was allocated to a subscriber unit, until a number of copies of the speech data are generated. A number of copies of the processed speech data may be generated for example between the interleaving and modulation processes. The number of copies may depend on the number of time slots allocated for the subscriber unit. Each copy may then be transmitted in one time slot allocated to the subscribe unit. In FIG. 4, user A transmits and receives information this way. As described in FIG. 4, user A receives the same speech data (DATA1) two times in downlink time slots 0 and 1, and transmits speech data (DATA2) two times in uplink time slots 1 and 4.

By transmitting multiple copies of the same payload of speech data time diversity is achieved. This improves the error tolerance of speech data, if the multiple copies are combined in a receiver. The receiver may be a receiver of a subscriber unit or a receiver of a base station. The receiver may combine the multiple copies of speech data according to a known combining technique. The combining technique may be for example maximal ratio combining (MRC), which is a signal combining technique in which each signal component is multiplied by a weight factor that is proportional to the signal amplitude. This means that strong signals are further amplified, while weak signals are attenuated. The combining technique may as well be selection combining, equal gain combining, or any other combining technique known in the art suitable from implementation point of view. The combining may be carried out between the demodulation and channel decoding operations.

In addition to time diversity, frequency diversity may be achieved by transmitting different copies of the same speech data in different TDMA frames (assuming of course that a different frequency band is used in different TDMA frames). The different copies may be transmitted in different TDMA frames in such a way that a tolerable end-to-end delay of speech data and, thus, fair speech quality is ensured. This procedure is illustrated in FIG. 6A. Let us assume, that four blocks of interleaved speech data T₁, T₂, T₃, T₄ are obtained from the interleaver. These blocks T₁, T₂, T₃, T₄ are then duplicated such that additional four blocks T₅, T₆, T₇, T₈ are generated. T₅ is a copy of T₁ T₆ is a copy of T₂, and so on. Each block is to be transmitted in one time slot. For example, the blocks may be transmitted in consecutive frames by transmitting blocks T₁ and T₃ in the first frame F1, blocks T₂ and T₄ in the second frame F2, blocks T₅ and T₇ in the third frame F3 and blocks T₆ and T₈ in the fourth frame F4. The transmission is naturally carried out using the time slots of a TDMA frame allocated to the subscriber unit. Because the blocks containing the same speech data are transmitted with a time separation of two TDMA frames, they benefit from both frequency and time diversity. Good time diversity is achieved, because the properties of the radio channel probably change within the time interval between the transmissions of the blocks. Thus, blocks containing the same speech data copies are better uncorrelated than if they were transmitted in the same or even in consecutive frames. The less correlation there is between the combined speech data blocks, the more diversity gain is achieved in the combining process. Naturally, copies of the same speech data may also be transmitted in consecutive TDMA frames, for example by transmitting blocks T₁ and T₂ in the first frame, blocks T₅ and T₆ in the second frame, blocks T₃ and T₄ in the third frame and block T₇ and T₈ in the fourth frame.

Transmit diversity may be further increased by increasing the time interval between the copies of the same speech data. According to an embodiment of the invention, the copies of the same speech data are transmitted with a time interval of four TDMA frames between the copies. This procedure is illustrated in FIG. 6B. Let us assume that two time slots per TDMA frame are allocated to a subscriber unit. Assume again that four blocks T₁, T₂, T₃, T₄ of interleaved speech data are obtained from the interleaver, and copies T₅, T₆, T₇, T₈ are also generated. T₁ may be transmitted in the first TDMA frame F1, T₂ in the second TDMA frame F2, and so on. Finally T₈ may be transmitted in the eighth TDMA frame F8. Now, so far, only a single time slot is used per TDMA frame. The next four blocks T₉, T₁₀, T₁₁, T₁₂ of interleaved speech data are obtained from the interleaver, and their respective copies T₁₃, T₁₄, T₁₅, T₁₆ are generated. Block T₉ may be transmitted in the fifth TDMA frame F5, T₁₀ in the sixth frame F6, and so on. Respectively, copies of blocks obtained from the interleaver before blocks T₁, T₂, T₃, T₄, may be transmitted in the first four TDMA frames F1 to F4. Thus, the transmission of consecutive series of blocks and their copies overlap in the transmission.

In the above example, the time interval between the copies of the same speech data (for example T₁ and T₅) is four TDMA frames. In order to achieve an even higher transmit diversity, the time interval between the copies may be even higher, such as eight TDMA frames.

Instead of using time diversity, the extra capacity provided to a subscriber unit in the form of allocated additional time slots may be used for applying stronger channel coding. The channel code may be the channel code implemented in the TDMA system in case a single time slot of a TDMA frame was allocated to a subscriber unit, but with a reduced code rate. Again, the data rate of the payload of speech data may remain the same, as if only one time slot were allocated to the subscriber unit. Using stronger channel coding means that there are more output bits per a set of input bits from the channel encoder, i.e. the code rate is decreased. Accordingly, the data rate at the output of the channel encoder is higher than in the previous example in which time diversity was used. Instead, the data rate at the input of the modulator may be the same, since copying the speech data and using stronger channel coding may result in the same data rate. Since the code rate is decreased, there is more data than is possible to transmit during one time slot per TDMA frame. Thus, transmission may be distributed over the allocated additional time slots of the TDMA frame. The code rate of the channel code may also be variable over the time slots, i.e. a different code rate may be used in transmission of speech data of a subscriber unit in different time slots of a TDMA frame.

Instead of using a single channel code for the speech data to be transmitted, the speech data may be encoded using concatenated channel codes. If multiple time slots of a TDMA frame were allocated to a subscriber unit the speech data may first be encoded using a channel code used if only a single time slot was allocated to a subscriber unit. The channel encoded speech data may then be again channel encoded using another channel code with a code rate proportional to the number of time slots of a TDMA frame allocated to the subscriber unit. For example, if two time slots of a TDMA frame allocated to the subscriber unit, the code rate of the second channel code may be 1/2. The channel encoded bits may also be punctured with a suitable puncturing scheme.

The channel encoded speech data may be interleaved using an interleaving method suitable from implementation point of view. According to the interleaving process of speech data of the GSM specifications, a block of 456 speech data bits is obtained from the channel encoder. This data is then divided in eight blocks of 57 bits such that the first block of 57 bits contains the bit numbers (0, 8, 16, . . . 448), the second one the bit numbers (1, 9, 17, . . . 449), etc. The last block of 57 bits will then contain the bit numbers (7, 15, . . . 455). Then the first four blocks of 57 bits are placed in the even-numbered bits of four consecutive time slots. The other four blocks of 57 bits are placed in the odd-numbered bits of the next four time slots. The interleaving depth of the GSM interleaving for speech data is thus eight time slots. A new data block also starts at every four bursts. The interleaver for speech channels is called a block diagonal interleaver. In the case of transmitting a plurality of copies of speech data, bits for interleaving are obtained after generating a number of copies of the speech data.

Interleaving may naturally be carried out over more time slots than eight. Interleaving depth may be for example 16 time slots. Interleaving depth may also be less than eight, if that is necessary for implementation reasons. It should be appreciated that the scope of the present invention is not limited to over how many time slots interleaving is performed.

In the example of FIG. 4, users B and C use the extra time slots for more efficient channel coding. As shown, users B and C transmit different data in different time slots. There are a total of three time slots allocated to user B, which means that user B may use stronger channel coding than user C.

In the above examples, the transmitter performing the above-mentioned operations of channel coding, interleaving, modulation and transmission of speech data, may be a transceiver unit of the GSM communication system. The transceiver unit may be a subscriber unit or a base station.

Next, a method of transmitting data in a GSM communication system according to an embodiment of the invention will be described with reference to the flow diagram of FIG. 4.

The process starts in step 500. A plurality of time slots of a TDMA frame is allocated to a subscriber unit in step 502. The allocation may be carried out by a network element, for example a base station controller. This results in extra capacity provided to the subscriber unit in the form of additional time slots. This extra capacity is used for increasing the redundancy of speech data in step 506. Redundancy may be increased by generating a plurality of copies of the speech data or reducing the channel code rate, for example.

Speech data with increased redundancy is transmitted in step 508. The transmission is carried out using the time slots allocated to the subscriber unit with the payload of the speech data corresponding to the payload of one time slot of a TDMA frame.

Steps 504 and 506 may be carried out in a transceiver unit, which may be a subscriber unit of the GSM system or a base station of the GSM communication network. Transmission of speech data according to an embodiment of the invention may be carried out from a subscriber unit to a base station (uplink) or from a base station to a subscriber unit (downlink).

The transmitted speech data with added extra redundancy is received in step 508, and processed in step 510. If redundancy is added to the speech data by generating a plurality of copies of the speech data, the processing of speech data in step 510 may comprise combining the plurality of copies according to a known criterion. The copies may be combined using MRC, for example.

Again, steps 508 and 510 may be carried out in a transceiver unit, which may be a subscriber unit of the GSM system or a base station of the GSM communication network. The process ends in step 512.

The transceiver unit and the network element of the type described above may be used for implementing the method, but other types of transceiver units and network elements may also be suitable for the implementation. In an embodiment, a computer program product encodes a computer program of instructions for executing a computer process of the above-described method of transmitting data in a GSM communication system. The computer program product may be distributed such that a portion of the computer program product is stored on the transceiver unit, and another portion is stored on the network element.

The computer program product may be implemented on a computer program distribution medium. The computer program distribution medium includes all manners known in the art for distributing software, such as a computer readable medium, a program storage medium, a record medium, a computer readable memory, a computer readable software distribution package, a computer readable signal, a computer readable telecommunication signal, and a computer readable compressed software package.

Even though the invention has been described above with reference to an example according to the accompanying drawings, it is clear that the invention is not restricted thereto but can be modified in several ways within the scope of the appended claims.

1. A data transmission method in a time division multiple access (TDMA) based communication system, the method comprising:
allocating a plurality of time slots of a TDMA frame to a subscriber unit for transmitting speech data;
increasing a redundancy of the speech data of the subscriber unit by exploiting extra capacity provided to the subscriber unit by a plurality of allocated time slots; and
transmitting the speech data with increased redundancy during the plurality of time slots allocated to the subscriber unit, a payload of the speech data corresponding to a payload of one time slot of the TDMA frame.

2. The method of claim 1, further comprising:
increasing the redundancy of the speech data by transmitting a plurality of copies of a same speech data using the plurality of allocated time slots of the TDMA frame;
receiving the plurality of copies of the same transmitted speech data in a receiver; and
processing the received plurality of copies of the same speech data according to a known criterion.

3. The method of claim 2, further comprising transmitting the plurality of copies of the same speech data in two TDMA frames with one TDMA frame without a copy of the same speech data between the two TDMA frames.

4. The method of claim 2, further comprising transmitting the plurality of copies of the same speech data with at least two complete TDMA frames between the said copies in order to achieve higher transmit diversity.

5. The method of claim 2, further comprising combining the received plurality of copies of the same speech data using maximal ratio combining.

6. The method of claim 1, further comprising increasing the redundancy by decreasing a code rate when channel encoding the speech data.

7. The method of claim 6, further comprising employing concatenated channel coding when a plurality of time slots of a TDMA frame has been allocated to the subscriber unit.

8. A transceiver unit of a time division multiple access (TDMA) based communication system, the transceiver unit comprising:
a communication interface to provide a connection to another transceiver unit; and
a control unit configured to
increase a redundancy of a speech data of a subscriber unit by exploiting extra capacity provided to the subscriber unit by a plurality of allocated time slots, and
transmit the speech data with increased redundancy during the plurality of time slots allocated to the subscriber unit, a payload of the speech data corresponding to a payload of one time slot of a TDMA frame.

9. The transceiver unit of claim 8 with the control unit being further configured to:
increase the redundancy of the speech data by transmitting a plurality of copies of a same speech data using the plurality of allocated time slots of the TDMA frame.

10. The transceiver unit of claim 9, with the control unit further configured to:
receive the plurality of copies of the same speech data through the communication interface; and
process the received plurality of copies of the same speech data according to a known criterion.

11. The transceiver unit of claim 10, with the control unit being further configured to:
combine the received plurality of copies of the same speech data using maximal ratio combining.

12. The transceiver unit of claim 9, with the control unit being further configured to transmit the copies of the same speech data in two TDMA frames with one TDMA frame without a copy of the same speech data between the two TDMA frames.

13. The transceiver unit of claim 9, with the control unit being further configured to transmit the copies of the same speech data with at least two complete TDMA frames between the said copies in order to achieve higher transmit diversity.

14. The transceiver unit of claim 8, with the control unit being further configured to increase the redundancy by decreasing a code rate when encoding the speech data to be transmitted.

15. The transceiver unit of claim 8, with the control unit being further configured to employ concatenated channel coding when a plurality of time slots of a TDMA frame has been allocated to the subscriber unit.

16. A network element of a time division multiple access (TDMA) based communication system, the network element comprising:
a control unit configured to allocate a plurality of time slots of a TDMA frame to a subscriber unit for transmitting speech data.

17. An arrangement for transmitting data in a time division multiple access (TDMA) based communication system, the arrangement comprising: a network element comprising means for allocating a plurality of time slots of a TDMA frame to a subscriber unit for transmitting speech data;
a transceiver unit comprising means for increasing a redundancy of the speech data of the subscriber unit by exploiting extra capacity provided to the subscriber unit by the plurality of allocated time slots; and
means for transmitting the speech data with increased redundancy during the plurality of time slots allocated to the subscriber unit, a payload of the speech data corresponding to a payload of one time slot of the TDMA frame.

18. A transceiver unit of a time division multiple access (TDMA) based communication system, the transceiver unit comprising:
communication means for providing a connection to another transceiver unit;
means for increasing a redundancy of speech data of a subscriber unit by exploiting extra capacity provided to the subscriber unit by a plurality of allocated time slots; and
means for transmitting the speech data with increased redundancy during the plurality of time slots allocated to the subscriber unit, a payload of the speech data corresponding to a payload of one time slot of a TDMA frame.

19. A computer program product embodied on a computer readable medium, the computer program controlling a data-processing device to perform the steps of:
allocating a plurality of time slots of a TDMA frame to a subscriber unit for transmitting speech data;
increasing a redundancy of the speech data of the subscriber unit by exploiting extra capacity provided to the subscriber unit by the plurality of allocated time slots; and
transmitting the speech data with increased redundancy during the plurality of time slots allocated to the subscriber unit, a payload of the speech data corresponding to a payload of one time slot of the TDMA frame.

20. A computer program distribution medium readable by a computer and encoding a computer program of instructions for executing a computer process for transmitting data in a time division multiple access (TDMA) based communication system, the process comprising:
allocating a plurality of time slots of a TDMA frame to a subscriber unit for transmitting speech data;
increasing a redundancy of the speech data of the subscriber unit by exploiting extra capacity provided to the subscriber unit by the plurality of allocated time slots; and
transmitting the speech data with increased redundancy during the plurality of time slots allocated to the subscriber unit, a payload of the speech data corresponding to a payload of one time slot of a TDMA frame.

21. The computer program distribution medium of claim 20, the distribution medium comprising at least one of the following mediums: a computer readable medium, a program storage medium, a record medium, a computer readable memory, a computer readable software distribution package, a computer readable signal, a computer readable telecommunications signal, a computer readable compressed software package.
